(19) United States
(12) Patent Application Publication
(10) Pub. No.: US 2017/0346350 A1
(43) Pub. Date: Nov. 30, 2017

(54) Permanent Magnet Motor and Home Appliance Having the Same

(71) Applicant: Johnson Electric S.A., Murten (CH)

(72) Inventors: Xiao Ping LV, Shenzhen (CN); Ching Hang Alan LEUNG, Hong Kong (CN); Wei Feng YUAN, Shenzhen (CN)

(21) Appl. No.: 15/601,644

(22) Filed: May 22, 2017

(30) Foreign Application Priority Data
May 26, 2016 (CN) 2016 1036 2410.X

(51) Int. Cl. H02K 1/02; H02K 1/17; H02K 13/00; H02K 23/40

(52) U.S. Cl. CPC H02K 1/02; H02K 23/40; H02K 1/17; H02K 13/006; H02K 2213/03

(57) ABSTRACT

A permanent magnet motor and a home appliance including the permanent magnet motor are provided. The permanent magnet motor includes a stator and a rotor rotatable relative to the stator. The rotor includes a rotary shaft, a rotor core fixed to the rotary shaft, a commutator fixed to the rotary shaft and adjacent the rotor core, and a rotor winding wound around poles of the rotor core and electrically connected with the commutator. The stator includes a cylindrical housing, a permanent magnet mounted to an inner surface of the housing, and brushes in sliding contact with the commutator. A ratio of an outer diameter of the rotor core to an outer diameter of the housing is 60% to 85%, and a wire diameter of the rotor winding is 0.12 mm to 0.23 mm. The present invention can provide higher output power without increasing sizes of the motor.

### CROSS REFERENCE TO RELATED APPLICATIONS

This non-provisional patent application claims priority under 35 U.S.C. §119(a) from Patent Application No. 201610362410.X filed in The People's Republic of China on May 26, 2016.

### FIELD OF THE INVENTION

The present invention relates to a permanent magnet motor, which is particularly suitable for home appliances.

### BACKGROUND OF THE INVENTION

At present, motors are widely used in various equipment and devices. For many devices such as vacuum cleaners and other home appliances, smaller, lighter and more powerful motors are desired, so as to reduce the size of the devices while maintaining the same device performance or to improve the device performance by increasing power of the motors without increasing the device size.

Some existing home appliances adopt high voltage direct current motors. A high voltage direct current motor includes a stator and a rotor. The stator includes a cylindrical housing and a permanent magnet fixed to an inner surface of the housing. The rotor includes a rotor core and a rotor winding wound around the rotor core. The rotor winding is powered by a high voltage direct current power supply. In an existing 600-series high voltage direct current motor, the housing of the motor has an outer diameter of about 36 mm, the rotor core has an outer diameter of about 22.8 mm, a ratio of the outer diameter of the rotor core to the outer diameter of the housing is about 63.3%, and an output power of the motor is usually less than 40 watts.

### SUMMARY OF THE INVENTION

Thus, there is a desire for a permanent magnet motor which can provide higher output power without increasing the size of the housing.

In one aspect, a permanent magnet motor is provided which includes a stator and a rotor rotatable relative to the stator. The rotor includes a rotary shaft, a rotor core fixed to the rotary shaft, a commutator fixed to the rotary shaft and adjacent the rotor core, and a rotor winding wound around poles of the rotor core and electrically connected with the commutator. The stator includes a cylindrical housing, a permanent magnet mounted to an inner surface of the housing, and brushes in sliding contact with the commutator. A ratio of an outer diameter of the rotor core to an outer diameter of the housing is 60% to 85%, and a wire diameter of the rotor winding is 0.12 mm to 0.23 mm.

Preferably, a ratio of the outer diameter of the rotor core to the outer diameter of the housing is 66% to 80%.

Preferably, the permanent magnet is a ferrite magnet.

Preferably, the ferrite magnet is made from material with a residual magnetic flux density Br being 4000 Gs to 4400 Gs and an intrinsic coercive force Hcj being 40000 e to 50000 e.

Preferably, the ferrite magnet is made from material with a residual magnetic flux density Br being 4200 Gs to 4400 Gs and an intrinsic coercive force Hcj being 44000 e to 46000 e.

Preferably, the outer diameter of the housing is 42.6 mm, the outer diameter of the rotor core is 29.5 mm, a radial length of a pole body of each pole of the rotor core is 7 mm, a circumferential width of the pole body is 1.75 mm, a minimum spacing between adjacent poles is 1.6 mm, and an output power of the permanent magnet motor is 140 watts.

Preferably, the permanent magnet is made from rare earth permanent magnetic material.

Preferably, the permanent magnet is an NdFeB magnet.

Preferably, the NdFeB magnet is made from material with a maximum magnetic energy product BHmax of 68 kJ/m³ to 80 kJ/m³, a residual magnetic flux density Br of 6500 Gs to 7000 Gs, and an intrinsic coercive force Hcj of 680 kA/m to 800 kA/m.

Preferably, the outer diameter of the housing is 35.7 mm, the outer diameter of the rotor core is 27.5 mm, a radial length of a pole body of each pole of the rotor core is 6.2 mm, a circumferential width of the pole body is 1.5 mm, a minimum spacing between adjacent poles is 1.6mm, and an output power of the permanent magnet motor is 100 watts.

Preferably, a rated output power of the permanent magnet motor is 100 watts to 200 watts.

Preferably, a power density of the permanent magnet motor is 260 W/kg to 480 W/kg

Preferably, the permanent magnet motor further includes electrical connection terminals for receiving a high voltage direct current power which is converted by a rectifier and an electrolytic capacitor from a 100V to 240V alternating current power, or receiving a 100V to 340V high voltage direct current power.

Preferably, the rotor core comprises 12 poles, the stator comprises 2 magnetic poles, and the commutator comprises 12 or 24 commutator segments.

Preferably, the permanent magnet motor is a high voltage direct current motor.

In another aspect, a home appliance is provided which includes the permanent magnet motor.

In the described embodiments of the present invention, since high-grade ferrite magnets are adopted, the thickness of the magnets can be reduced while ensuring sufficient magnetic performance, which makes it possible to increase the size of the rotor core. As such, the motor can provide more space for accommodating more rotor windings. Further, since the wire diameter of the rotor winding is large, a higher output power can be provided. Furthermore, the high voltage direct current motor of the present invention has a higher power density. In addition, due to greater thermal mass, temperature rising of the motor during operation can be reduced. Moreover, since the thicker wire is allowed to be used in the rotor winding, copper loss of the motor can also be reduced.

### BRIEF DESCRIPTION OF THE DRAWINGS

FIG. 1 shows a permanent magnet motor according to a preferred embodiment of the present invention.

FIG. 2 is a longitudinal cross sectional view of the permanent magnet motor of FIG. 1.

FIG. 3 shows a rotor core of the permanent magnet motor of FIG. 1.

### DETAILED DESCRIPTION OF THE PREFERRED EMBODIMENTS

The technical solutions and beneficial effects of the present invention are best understood from the following detailed description of embodiments of the present disclosure, with reference to the accompanying drawings. It is to be understood that the figures are merely examples to explain the present invention and are not intended to limit the present invention. Dimensions shown in the figures are generally chosen for convenience and clarity of presentation and are not necessarily shown to scale.

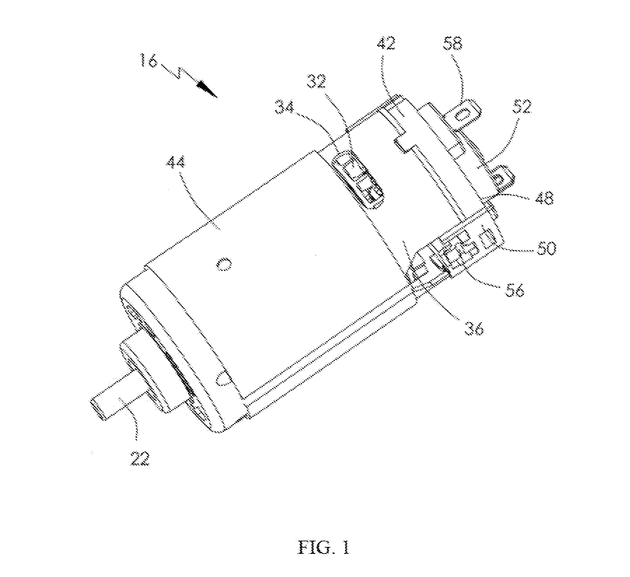

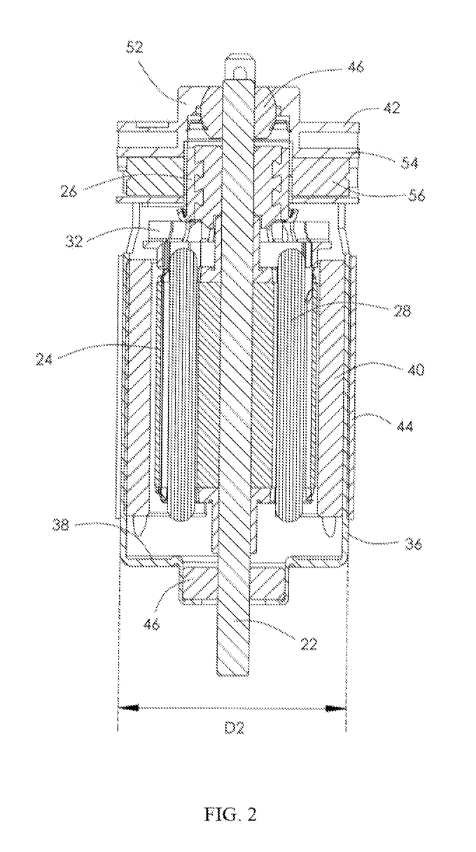

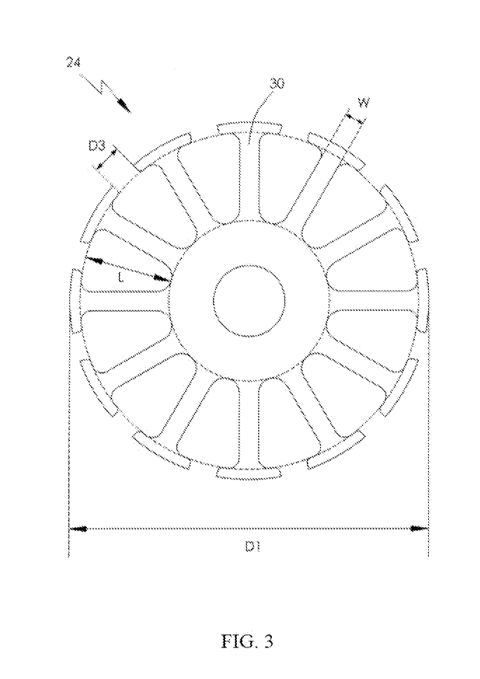

Referring to FIG. 1 to FIG. 3, a permanent magnet motor 16 of the present disclosure may be applied in a home appliance such as a vacuum cleaner. The home appliance includes a driven mechanism (not shown), and the permanent magnet motor 16 is used to drive the driven mechanism. In a preferred embodiment, the permanent magnet motor 16 includes a stator and a rotor rotatable relative to the stator. The rotor includes a rotary shaft 22, a rotor core 24 fixed to the rotary shaft 22, a commutator 26 fixed to the rotary shaft 22 and adjacent the rotor core 24, and a rotor winding 28 wound around each pole 30 of the rotor core 24 and electrically connected with the commutator 26. The rotor core 24 may include a plurality of rotor core laminations which are stacked along an axial direction of the rotary shaft 22. Slots are defined between adjacent poles of the rotor for allowing the rotor winding to pass therethrough. A fan 32 is fixed to the rotor core 24, and cooperates with at least one opening 34 in the housing 36 to cool the motor with airflow generated during rotation. In the present embodiment, the opening 34 is defined in the housing 36. In another embodiment, the opening 34 may be defined in an endcap of the permanent magnet motor 16. Preferably, the rotor core includes 12 poles, and the commutator 26 includes 24 commutator segments. Alternatively, the commutator may also include 12 commutator segments. In the present embodiment, the permanent magnet motor 16 is a high voltage direct current motor, and a wire diameter of the rotor winding 28 is 0.12 mm to 0.23 mm.

The stator includes a cylindrical housing 36, two permanent magnets 40, an endcap 42, and a pair of brush assemblies. The housing 36 extends along the axial direction of the stator and has an open end and a closed end 38. The permanent magnets 40 are fixed to an inner surface of the housing 36. The endcap 42 closes the open end of the hosing 36. The housing 36 is made from a magnetic conductive material. The endcap 42 is fixedly installed to the housing 36. The rotary shaft 22 is rotatably supported by two bearings 46 which are located at the endcap 42 and the closed end 38 of the housing 36, respectively. The rotor core 24 and the permanent magnets 40 are opposed to each other with an air gap defined therebetween.

The endcap 42 includes a base plate 48, an annular sidewall 50 extending axially inwardly from the base plate 48, and a bearing seat 52 extending axially outwardly from the base plate 48 for supporting one of the bearings 46. The sidewall 50 and the base plate 48 together define a chamber for accommodating the commutator 26. Each brush assembly includes a brush holder 54. The brush holder 54 extends radially inwardly from the sidewall 50 and communicates with the chamber. Brushes 56 are slidably mounted in the brush holder 54, and are elastically supported by elastic members (not shown) into sliding contact with the commutator 26. The endcap 42 is further provided with two electrical connection terminals 58 for electrically connecting with an external power supply. Each electrical connection terminal 58 is electrically connected with corresponding brush 56 through an electrical conductor (for example, a brush pigtail which is not shown).

In the present embodiment, the two electrical connection terminals 58 electrically connecting with the external power supply may be implemented through electrically connecting the two electrical connection terminals 58 with a high voltage direct current power which is converted by a rectifier and an electrolytic capacitor from a 100V to 240V alternating current power, or through electrically connecting the two electrical connection terminals 58 with a 100V to 340V high voltage direct current power. As such, the high voltage direct current power is supplied to the rotor winding 28 through the electrical connection terminals 58, the brushes 56 and the commutator 26.

In the present embodiment, the permanent magnets 40 may be high-grade ferrite magnets, which are preferably made from a material with a maximum magnetic energy product BHmax being greater than 4.3 MGOe, with a residual magnetic flux density Br being 4000 Gs to 4400 Gs, and with an intrinsic coercive force Hcj being 40000 e to 50000 e. More preferably, the ferrite magnets may be made from a material with a residual magnetic flux density Br being 4200 Gs to 4400 Gs, with an intrinsic coercive force Hcj being 44000 e to 46000 e and with a maximum magnetic energy product BHmax being 4.3 MGOe to 4.7 MGOe.

In one embodiment of the present invention, a ratio of an outer diameter D1 of the rotor core 24 to an outer diameter D2 (not including a thickness of a flux ring 44) of the housing 36 is 60% to 85%. Preferably, the ratio of the outer diameter D1 of the rotor core 24 to the outer diameter D2 (not including the thickness of the flux ring 44) of the housing 36 is 66% to 80%.

In other embodiments, the permanent magnets 40 may also be made from rare earth permanent magnetic materials, which are preferably made from an NdFeB material with the maximum magnetic energy product BHmax being 68 kJ/m³ to 80 kJ/m³, with a residual magnetic flux density Br being 6500 Gs to 7000 Gs, and with an intrinsic coercive force Hcj being 680 kA/m to 800 kA/m. A ratio of the outer diameter D1 of the rotor core 24 to the outer diameter D2 (not including the thickness of the flux ring 44) of the housing 36 is 60% to 85%.

In the described embodiments of the present invention, since high-grade ferrite magnets or rare earth permanent magnetic materials are adopted, the thickness of the magnets can be reduced while ensuring sufficient magnetic performance, which makes it possible to increase the size of the rotor core. As such, the motor can provide more space for accommodating more rotor windings. Further, since the wire diameter of the rotor winding is 0.12 mm to 0.23 mm which is large, a higher output power, e.g. 100 W to 200 W, can be provided. Furthermore, the high voltage direct current motor of the present invention has a higher power density which can be 260 W/kg to 480 W/kg. In addition, due to greater thermal mass, temperature rising of the motor during operation can be reduced. Moreover, since the thicker wire is allowed to be used in the rotor winding, copper loss of the motor can also be reduced.

For instance, in an example of a 600-series high voltage direct current motor, the permanent magnets 40 are made from the NdFeB material, the outer diameter D2 of the housing is 35.7 mm, the outer diameter D1 of the rotor core is increased to 27.5 mm, the ratio of the outer diameter of the rotor core to the outer diameter of the housing is increased to 77%, and the output power of the motor can be increased to 100 watts. Preferably, a radial length L of a pole body of the pole of the rotor core is 6.2 mm, a circumferential width W of the pole body is 1.5 mm, and a minimum spacing D3 between adjacent poles is 1.6 mm. It is to be understood that these dimensions may vary within about 10%.

In an example of a 700-series high voltage direct current motor according to one preferred embodiment of the present invention, the permanent magnets 40 are ferrite magnets, the outer diameter D2 of the housing is 42.6 mm, the outer diameter D1 of the rotor core is increased to 29.5 mm, the ratio of the outer diameter of the rotor core to the outer diameter of the housing is increased to 69.2%, and the output power of the motor can be increased to 140 watts. Preferably, the radial length L of the pole body of the pole of the rotor core is 7 mm, the circumferential width W of the pole body is 1.75 mm, and the minimum spacing D3 between adjacent poles is 1.6 mm. It is to be understood that these dimensions may vary within about 10%.

The above are only exemplary embodiments of the present invention and are not intended to limit the present invention. Various modifications, variations and improvements may be made without departing from spirit and principle of the present invention. For example, the stator may also include four or more permanent magnets. These should also be considered to fall within the scope of protection of the present invention.

1. A permanent magnet motor comprising:
a stator comprising a cylindrical housing, a permanent magnet mounted to an inner surface of the housing, and brushes; and
a rotor rotatable relative to the stator, the rotor comprising a rotary shaft, a rotor core fixed to the rotary shaft, a commutator fixed to the rotary shaft and adjacent the rotor core, and a rotor winding wound around poles of the rotor core and electrically connected with the commutator, the brushes of the stator being in sliding contact with the commutator, a ratio of an outer diameter of the rotor core to an outer diameter of the housing being 60% to 85%, and a wire diameter of the rotor winding being 0.12 mm to 0.23 mm.

2. The permanent magnet motor according to claim 1, wherein a ratio of the outer diameter of the rotor core to the outer diameter of the housing is 66% to 80%.

3. The permanent magnet motor according to claim 1, wherein the permanent magnet is a ferrite magnet.

4. The permanent magnet motor according to claim 3, wherein the ferrite magnet is made from material with a residual magnetic flux density Br being 4000 Gs to 4400 Gs and an intrinsic coercive force Hcj being 40000 e to 50000 e.

5. The permanent magnet motor according to claim 4, wherein the ferrite magnet is made from material with a residual magnetic flux density Br being 4200 Gs to 4400 Gs and an intrinsic coercive force Hcj being 44000 e to 46000 e.

6. The permanent magnet motor according to claim 4, wherein the outer diameter of the housing is 42.6 mm, the outer diameter of the rotor core is 29.5 mm, a radial length of a pole body of each pole of the rotor core is 7 mm, a circumferential width of the pole body is 1.75 mm, a minimum spacing between adjacent poles is 1.6 mm, and an output power of the permanent magnet motor is 140 watts.

7. The permanent magnet motor according to claim 1, wherein the permanent magnet is made from rare earth permanent magnetic material.

8. The permanent magnet motor according to claim 7, wherein the permanent magnet is an NdFeB magnet.

9. The permanent magnet motor according to claim 8, wherein the NdFeB magnet is made from material with a maximum magnetic energy product BHmax of 68 kJ/m³ to 80 kJ/m³, a residual magnetic flux density Br of 6500 Gs to 7000 Gs, and an intrinsic coercive force Hcj of 680 kA/m to 800 kA/m.

10. The permanent magnet motor according to claim 9, wherein the outer diameter of the housing is 35.7 mm, the outer diameter of the rotor core is 27.5 mm, a radial length of a pole body of each pole of the rotor core is 6.2 mm, a circumferential width of the pole body is 1.5 mm, a minimum spacing between adjacent poles is 1.6 mm, and an output power of the permanent magnet motor is 100 watts.

11. The permanent magnet motor according to claim 1, wherein a rated output power of the permanent magnet motor is 100 watts to 200 watts.

12. The permanent magnet motor according to claim 1, wherein a power density of the permanent magnet motor is 260 W/kg to 480 W/kg.

13. The permanent magnet motor according to claim 1, further comprising electrical connection terminals for receiving a high voltage direct current power which is converted by a rectifier and an electrolytic capacitor from a 100V to 240V alternating current power, or receiving a 100V to 340V high voltage direct current power.

14. The permanent magnet motor according to claim 1, wherein the rotor core comprises 12 poles, the stator comprises 2 magnetic poles, and the commutator comprises 12 or 24 commutator segments.

15. The permanent magnet motor according to claim 1, wherein the permanent magnet motor is a high voltage direct current motor.

16. A home appliance comprising the permanent magnet motor according to claim 1.
